(19) United States
(12) Patent Application Publication
(10) Pub. No.: US 2023/0329413 A1
(43) Pub. Date: Oct. 19, 2023

(54) HAIRCARE APPLIANCE

(71) Applicant: Dyson Technology Limited, Wiltshire (GB)

(72) Inventors: Christopher James BOON, Manila (PH); Edward Sebert Maurice SHELTON, Swindon (GB); Stephen Benjamin COURTNEY, Gloucester (GB); Yuen Kee LEOW, Singapore (SG); Glenn Raymond WARDLE, Swindon (GB)

(73) Assignee: Dyson Technology Limited, Wiltshire (GB)

(21) Appl. No.: 18/028,232

(22) PCT Filed: Sep. 16, 2021
(86) PCT No.: PCT/GB2021/052402

§ 371 Date: Mar. 24, 2023

(30) Foreign Application Priority Data
Sep. 30, 2020 (GB) 2015444.9
Jun. 22, 2021 (GB) 2108915.6

(51) Int. Cl. A45D 20/12; H05B 1/02

(52) U.S. Cl. CPC A45D 20/12; H05B 1/0244

(57) ABSTRACT

A haircare appliance has a heater housing and a heater assembly disposed in the heater housing. The haircare appliance has an airflow generator for generating an airflow through the heater housing, and the airflow generator is disposed in the heater housing. The haircare appliance has a circuitry housing remote from the heater housing, and airflow generator control circuitry is disposed in the circuitry housing. A wire extends from the circuitry housing to the heater housing, and the wire couples the airflow generator control circuitry to the airflow generator.

### FIELD OF THE INVENTION

The present invention relates to a haircare appliance.

### BACKGROUND OF THE INVENTION

Haircare appliances are generally used to treat or style hair, and some haircare appliances may treat or style hair using airflow along with heat. Such haircare appliances are typically held by a user and moved relative to the hair to obtain desired treatment or styling.

### SUMMARY OF THE INVENTION

According to a first aspect of the present invention there is provided a haircare appliance comprising a heater housing, a heater assembly disposed in the heater housing, an airflow generator for generating an airflow through the heater housing, the airflow generator disposed in the heater housing, a circuitry housing remote from the heater housing, airflow generator control circuitry disposed in the circuitry housing, and a wire extending from the circuitry housing to the heater housing, the wire coupling the airflow generator control circuitry to the airflow generator.

The haircare appliance according to the first aspect of the present invention may be beneficial as the airflow generator is disposed in the heater housing, and the airflow generator control circuitry is disposed in circuitry housing remote from the heater housing. In particular, removal of the airflow generator control circuitry from the heater housing may enable the heater housing to be smaller and/or lighter than an arrangement where both the airflow generator and the airflow generator control circuitry are disposed in the heater housing, for example. This may provide an improved user experience, for example where the heater housing is configured to be held by a user in use. This may also increase available space within a housing of a given size.

The heater housing may comprise a handle portion to be held by a user in use. The circuitry housing may be configured to be located remote from a user in use, for example such that the circuitry housing is not directly held by a user in use. The heater assembly may be configured to heat airflow through the heater housing in use.

The wire may comprise a current path from the airflow generator control circuitry to the airflow generator, or vice versa. The wire may be disposed in an electrical cable, the electrical cable extending from the circuitry housing to the heater housing.

The circuitry housing may be an in-line housing i.e. a housing that connects between two wires with the heater housing at the distal end of one of the wires and a plug at the distal end of the other one of the wires. Alternatively, the circuitry housing may be formed as part of a plug unit which plugs into a socket for receiving a power source for the appliance.

The haircare appliance may comprise a pair of wires extending from the circuitry housing, the pair of wires coupling the airflow generator control circuitry to the airflow generator. A first wire of the pair of wires may comprise a live wire, and a second wire of the pair of wires may comprise a neutral wire, or vice versa. The pair of wires may comprise a pair of airflow generator current wires.

The airflow generator control circuitry may comprise drive circuitry for, example circuitry which can modify electrical power to drive rotation of one or more components of the airflow generator. The drive circuitry may, for example, be configured to commutate current flow provided to the airflow generator.

The airflow generator control circuitry may comprise a switch for controlling current flow to the airflow generator. Switches may comprise relatively large electrical components, and so locating the switch in the circuitry housing may increase available space within the heater housing, or may enable use of a smaller and/or lighter heater housing. This may provide an improved user experience, for example where the heater housing is configured to be held by a user in use. The switch may, for example, comprise an electronically controlled switch. The switch may comprise a field-effect transistor (FET). The airflow generator may comprise a plurality of switches for controlling current flow to the airflow generator. The airflow generator may comprise at least one half-bridge of switches.

The airflow generator may comprise a motor, and an impeller driven by the motor, and a rotational position of the impeller may be calculated using current and/or voltage values communicated to the airflow generator control circuitry over the wire. This may be beneficial as it may remove the need for additional communications wiring to be provided between the airflow generator circuitry and the airflow generator to provide a signal indicative of the position of the impeller, for example a signal provided by a hall sensor of the motor or the like. The motor may be drive using a sensorless control scheme. The airflow generator control circuitry may comprise control circuitry for controlling current flow to and from the motor. The motor may comprise a brushless permanent magnet motor.

The motor may comprise a single-phase motor. This may reduce the number of wires required to extend from the circuitry housing to the heater housing compared to, for example, a similar arrangement that utilises a three-phase motor. A reduced number of wires may provide for an electrical cable of increased flexibility, which may enhance a user experience. A single-phase motor may also require fewer switches for operation than, for example, a three-phase motor, which may reduce the number of components required, and hence reduce weight and cost, compared to a similar haircare appliance that utilises a three-phase motor. Furthermore, an increased number of switches may result in an increased amount of heat generated in use, which may increase the thermal management requirements of the circuitry housing. Use of a single-phase motor may thereby ease thermal management requirements of the circuitry housing, for example compared to a similar haircare appliance that utilises a three-phase motor.

The haircare appliance may comprise a pair of power supply wires for providing electrical power to the heater assembly, the pair of power supply wires extending from the circuitry housing to the heater housing, and a relay disposed within the circuitry housing, the relay interrupting a current supply path from a mains power supply to one of the power supply wires.

Relays may comprise relatively large electronic components, and placing the relay in the circuitry housing may provide a smaller and/or lighter heater housing than, for example, a comparable arrangement where a relay is disposed in the heater housing. This may provide an improved user experience, for example where the heater housing is configured to be held by a user in use.

The pair of power supply wires may be configured to provide electrical power to drive circuitry of the heater assembly, for example circuitry which can modify the electrical power to drive a heater of the heater assembly. The drive circuitry may, for example, be configured to drive a heater of the heater assembly using one of, or a combination of, burst fire and phase angle control.

The haircare appliance may comprise a thermal protection circuit disposed within the circuitry housing, and the relay may be controlled by the thermal protection circuit. This may provide a smaller and/or lighter heater housing than, for example, a haircare appliance that utilises a thermal fuse located within a heater housing. This may provide an improved user experience, for example where the heater housing is configured to be held by a user in use. The relay may be configured to be held in a closed position, for example by the thermal protection circuit, when an operating temperature of the heater assembly is below a pre-determined threshold, for example when the heater assembly is operating at a temperature within a pre-determined acceptable temperature range in use. The relay may be configured to be held in an open position, for example by the thermal protection circuit, when an operating temperature of the heater assembly is above a pre-determined threshold, for example when the heater assembly is operating at a temperature above a pre-determined acceptable temperature in use.

The thermal protection circuit may be coupled to a temperature sensor disposed within the heater housing, for example coupled by a pair of thermal protection circuit wires. The thermal protection circuit wires may communicate a resistance measurement from the temperature sensor to the thermal protection circuit in use, for example a resistance indicative of an operating temperature of the heater assembly.

The haircare appliance may be configured to be powered by a mains power supply, and the haircare appliance may comprise a power converter for providing electrical power to the airflow generator control circuitry, the power converter disposed in the circuitry housing. Locating a power converter in the circuitry housing may provide a lighter and/or smaller heater housing than, for example, an arrangement where a power converter is located in the heater housing. This may provide an improved user experience, for example where the heater housing is configured to be held by a user in use. The power converter may comprise an AC-DC converter for converting AC electrical power from the mains power supply to DC electrical power for driving the airflow generator. The power converter may comprise a rectifier. The haircare appliance may comprise a power supply connector for connecting to an AC mains power supply.

The heater assembly may comprise a heater controller, the heater controller in communication with the airflow generator control circuitry via a pair of communication wires extending from the circuitry housing to the heater housing, and the power converter may be configured to supply electrical power to the heater controller via the pair of communication wires. This may reduce a number of wires required compared to, for example, an arrangement where separate wires are used for communications and power supply to the heater controller. This may allow for use of a more flexible electrical cable, which may allow for greater flexibility for a user of the haircare appliance when the heater housing is grasped by the user in use. The airflow generator control circuitry may comprise an airflow generator controller in communication with the heater controller via the communication wires. The airflow generator controller and the heater controller may be configured to communicate with each other to control properties of output airflow of the haircare appliance and/or to verify correct operation of the haircare appliance.

The haircare application may comprise communication circuitry for injecting communication signals onto and decoding communication signals from, the communication wires. The communication circuitry may be disposed in both the circuitry housing and the heater housing, for example with both encoding and decoding circuitry present in each of the circuitry housing and the heater housing.

The heater controller may be configured to communicate with the airflow generator control circuitry using low voltage differential signalling. Use of low voltage differential signalling may increase immunity to noise from other wires compared to other signalling methods, may reduce the level of noise emission relative to other signalling methods, and may be relatively low cost.

The haircare appliance may comprise a further power converter disposed in the heater housing, the further power converter configured to modify electrical power received via the pair of communication powers and to pass modified electrical power to the heater controller. The further power converter may comprise a DC-DC converter. The further power converter may comprise a step-down converter for stepping down a voltage of electrical power received via the pair of communication wires. This may provide low voltage power supply for low voltage components disposed in the heater housing.

The haircare appliance may comprise no more than eight wires extending from the circuitry housing to the heater housing within an electrical cable. An electrical cable having more than eight wires may have a level of rigidity such that the level of rigidity may negatively impact on a user experience in use, for example with the level of rigidity leading to the haircare appliance being unwieldy for a user.

According to a second aspect of the present invention there is provided a haircare appliance comprising a heater housing, a circuitry housing remote from the heater housing, an airflow generator for generating an airflow through the heater housing, airflow generator control circuitry for controlling the airflow generator, a heater assembly for heating airflow through the heater housing, the heater assembly comprising a heater, a heater controller, and heater drive circuitry controlled by the heater controller, a temperature sensor for sensing a temperature of airflow through the heater housing, a thermal protection circuit for receiving a signal from the temperature sensor, a power supply connector for connecting to a mains power supply, and a power converter for supplying DC electrical power to the airflow generator control circuitry and the heater controller, wherein the power supply connector is connected to the circuitry housing, the airflow generator, the heater assembly and the temperature sensor are disposed in the heater housing, the airflow generator control circuitry, the thermal protection circuit and the power converter are disposed in the circuitry housing, the airflow generator control circuitry comprises an airflow generator controller and airflow generator drive circuitry, the airflow generator drive circuitry is electrically coupled to the airflow generator by a first coupling, the heater controller is communicatively coupled to the airflow generator controller by a second coupling, the temperature sensor is electrically coupled to the thermal protection circuit by a third coupling, the power converter is electrically coupled to the heater controller and the airflow generator controller by a fourth coupling, the heater drive circuitry is electrically coupled to the power supply connector by a fifth coupling, and the first, second third, fourth and fifth couplings collectively comprise no more than eight wires extending between the circuitry housing and the heater housing in an electrical cable.

The haircare appliance according to the second aspect of the present invention may be beneficial as the airflow generator, the heater assembly and the temperature sensor are disposed in the heater housing, and the airflow generator control circuitry, the thermal protection circuit and the power converter are disposed in the circuitry housing, In particular, removal of the airflow generator control circuitry, the thermal protection circuit and the power converter from the heater housing may enable the heater housing to be smaller and/or lighter than an arrangement where these components are disposed in the heater housing, for example. This may provide an improved user experience, for example where the heater housing is configured to be held by a user in use. This may also increase available space within a housing of a given size.

However, locating the airflow generator control circuitry in the circuitry housing may increase the number of electrical connections, ie wires, between the circuitry housing and the heater housing. This may lead to an electrical cable of increased thickness extending from the circuitry housing to the heater housing. An increase in cable thickness may have a level of rigidity such that the level of rigidity may negatively impact on a user experience in use, for example with the level of rigidity leading to the haircare appliance being unwieldy for a user. By having the first, second third, fourth and fifth couplings collectively comprise no more than eight wires extending between the circuitry housing and the heater housing in an electrical cable. all desired electrical and communicative connections may be made without an excessively thick and rigid electrical cable.

The second and fourth couplings may collectively comprise a pair of communication wires that both communicatively couple the heater controller to the airflow generator controller and electrically couple the heater controller to the power converter. By using one pair of wires for both communicative and electrical coupling, the number of wires extending from the circuitry housing to the heater housing may be minimised, thereby minimising a thickness of an electrical cable extending from the circuitry housing to the heater housing, and improving user experience, for example by providing an increased range of motion between the heater housing and the circuitry housing when the heater housing is moved by a user in use. The pair of communication wires may be disposed in the electrical cable.

The heater controller may be configured to communicate with the airflow generator control circuitry using low voltage differential signalling. Use of low voltage differential signalling may increase immunity to noise from other wires compared to other signalling methods, may reduce the level of noise emission relative to other signalling methods, and may be relatively low cost.

The first coupling may comprise a pair of airflow generator current wires electrically coupling the airflow generator drive circuitry to the airflow generator. The pair of airflow generator current wires may be disposed in the electrical cable.

The airflow generator may comprise a motor, and an impeller driven by the motor, and a rotational position of the impeller may be calculated using current and/or voltage values communicated to the airflow generator control circuitry over the wire. This may be beneficial as it may remove the need for additional communications wiring to be provided between the airflow generator circuitry and the airflow generator to provide a signal indicative of the position of the impeller, for example a signal provided by a hall sensor of the motor or the like. The motor may be drive using a sensorless control scheme. The airflow generator control circuitry may comprise control circuitry for controlling current flow to and from the motor. The motor may comprise a brushless permanent magnet motor.

The motor may comprise a single-phase motor. This may reduce the number of wires required to extend from the circuitry housing to the heater housing compared to, for example, a similar arrangement that utilises a three-phase motor. A reduced number of wires may provide for an electrical cable of increased flexibility, which may enhance a user experience. A single-phase motor may also require fewer switches for operation than, for example, a three-phase motor, which may reduce the number of components required, and hence reduce weight and cost, compared to a similar haircare appliance that utilises a three-phase motor. Furthermore, an increased number of switches may result in an increased amount of heat generated in use, which may increase the thermal management requirements of the circuitry housing. Use of a single-phase motor may thereby ease thermal management requirements of the circuitry housing, for example compared to a similar haircare appliance that utilises a three-phase motor.

The third coupling may comprise a pair of thermal protection circuit wires electrically coupling the thermal protection circuit to the temperature sensor. The pair of thermal protection circuit wires may be disposed in the electrical cable.

The fifth coupling may comprise a pair of power supply wires electrically coupling the heater drive circuitry to the power supply connector. The pair of power supply wires may extend through the circuitry housing, and may, for example, be connected to the power supply connector via a filter disposed within the circuitry housing. The pair of power supply wires may be disposed in the electrical cable.

According to a third aspect of the present invention there is provided a haircare appliance comprising a heater housing, a circuitry housing remote from the heater housing, an airflow generator for generating an airflow through the heater housing, an airflow generator controller for controlling the airflow generator, a heater for heating an airflow through the heater housing, a heater controller for controlling the heater, and a power converter for supplying DC electrical power to the airflow generator controller and the heater controller, wherein the airflow generator, the heater and the heater controller are disposed in the heater housing, the airflow generator controller and the power converter are disposed in the circuitry housing, and the heater controller is electrically coupled to the power converter and communicatively coupled to the airflow generator controller by a pair of wires extending from the circuitry housing to the heater housing.

The haircare appliance according to the third aspect of the present invention may be beneficial as the airflow generator, the heater and the heater controller are disposed in the heater housing, and the airflow generator controller and the power converter are disposed in the circuitry housing, In particular, removal of the airflow generator controller and the power converter from the heater housing may enable the heater housing to be smaller and/or lighter than an arrangement where these components are disposed in the heater housing, for example. This may provide an improved user experience, for example where the heater housing is configured to be held by a user in use. This may also increase available space within a housing of a given size.

However, locating the airflow generator control circuitry in the circuitry housing may increase the number of electrical connections, ie wires, between the circuitry housing and the heater housing. This may lead to an electrical cable of increased thickness extending from the circuitry housing to the heater housing. An increase in cable thickness may have a level of rigidity such that the level of rigidity may negatively impact on a user experience in use, for example with the level of rigidity leading to the haircare appliance being unwieldy for a user. By utilising a pair of wires that both electrically couple the power converter to the heater controller and communicatively couple the airflow generator controller to the heater controller, a reduced number of wires may be required compared to, for example, an arrangement where separate pairs of wires are required for both power supply and communications.

Optional features of aspects of the present invention may be equally applied to other aspects of the present invention, where appropriate.

### BRIEF DESCRIPTION OF THE DRAWINGS

FIG. 1 is a perspective view of an embodiment of a haircare appliance;

FIG. 2 is a schematic view illustrating internal components of the haircare appliance of FIG. 1;

FIG. 3 illustrates communication circuitry of the haircare appliance of FIG. 1;

FIG. 4 is an enlarged view of a circuitry housing of the haircare appliance of FIG. 1;

FIG. 5 is a perspective view of an attachment member utilised in the haircare appliance of FIG. 1;

FIG. 6 is an enlarged view of a portion of the circuitry housing of FIG. 4 engaged with the attachment member of FIG. 5;

FIG. 7 is a schematic view illustrating a stress-release feature used in conjunction with the attachment member of FIG. 5;

FIG. 8 is a perspective view of a wire guide utilised in the haircare appliance of FIG. 1;

FIG. 9 is a schematic end view of the wire guide of FIG. 8;

FIG. 10 is a schematic view illustrating a position of the wire guide of FIG. 8 within the haircare appliance of FIG. 1;

FIG. 11 is a perspective view of an alternative circuitry housing of the haircare appliance of FIG. 1;

FIG. 12a is an exploded perspective view of the alternative circuitry housing of FIG. 11;

FIG. 12b is a perspective view of an inner surface of a power connector;

FIG. 12c is a perspective view of a terminal suitable for use with a temperature sensing arrangement on the power connector;

FIG. 13 is an exploded view of different layers related to the inlet;

FIG. 14 is a perspective view of an inlet;

FIG. 15 is cross section through an appliance according to the invention;

FIG. 16 is an exploded view of an appliance according to the invention;

FIG. 17 is an exploded view of some of the internal features of the first part of the heater housing region of the appliance of FIG. 16;

FIG. 18 is an exploded view of some of the internal features of the second part of the heater housing of the appliance of FIG. 16;

FIG. 19 is an exploded view of a UI for an appliance according to the invention;

FIG. 20a and FIG. 20b are external and internal views respectively of an outlet of an appliance according to the invention;

FIG. 21 is a perspective view of an embodiment of a haircare appliance; and

FIG. 22 is a perspective view of an embodiment of an attachment suitable for use with the haircare appliance of FIG. 21.

### DETAILED DESCRIPTION OF THE INVENTION

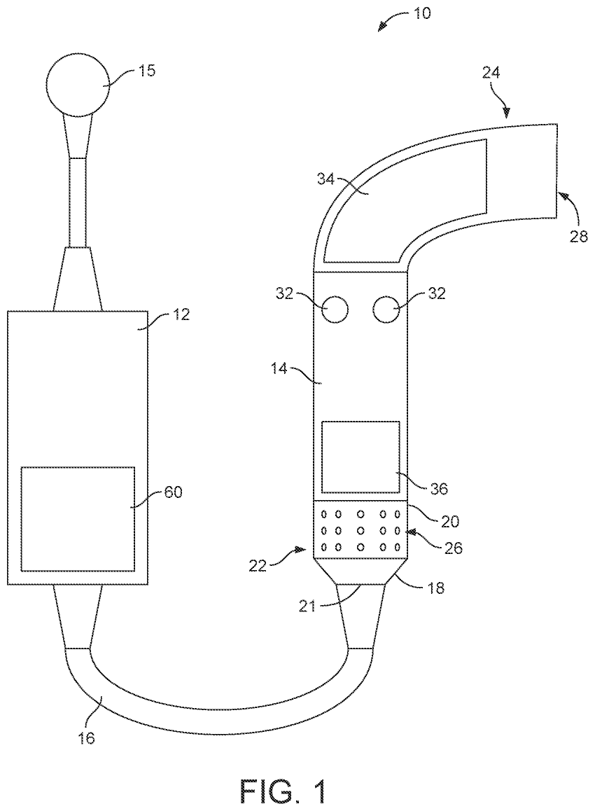

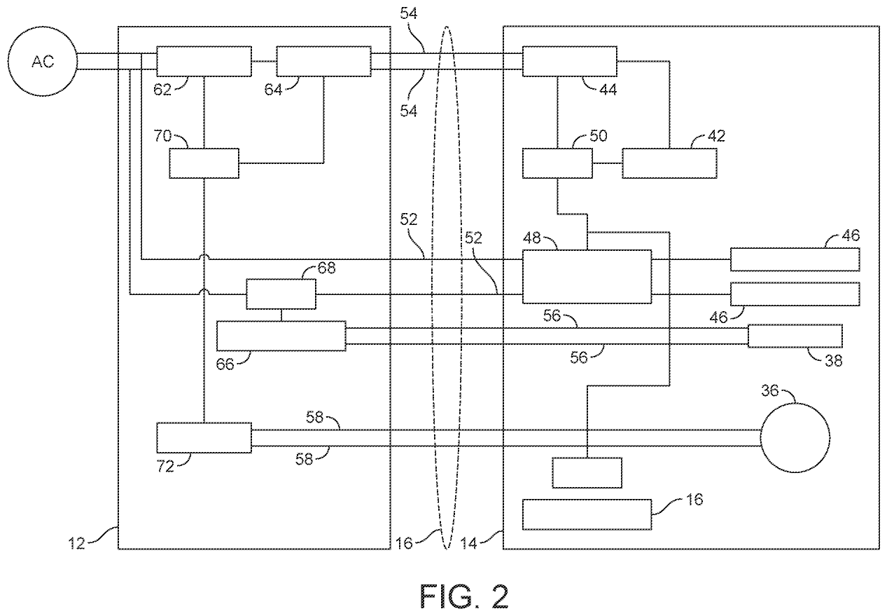

A haircare appliance, generally designated 10, is shown schematically in FIGS. 1 and 2. The haircare appliance 10 in the embodiment of FIGS. 1 and 2 is a hairdryer, although it will be appreciated that some of the teachings discussed herein may be applied to other types of haircare appliance, for example hair straighteners or hair curlers or the like.

The haircare appliance 10 comprises a circuitry housing 12, a heater housing 14, and an electrical cable 16 extending from the circuitry housing 12 to the heater housing 14. The circuitry housing 12 defines an enclosure that houses a number of electronic components as will be described hereinafter, and the electronic components within the circuitry housing 12 are coupled to corresponding electronic components within the heater housing 14 by wires held within the electrical cable 16. Whilst referred to as wires, it will be appreciated that each wire may comprise more than one electrically conducting filament, for example as is the case with a braided wire, with the overall structure of multiple filaments being considered a wire. A power connector 15 in the form of a plug is coupled to the opposite side of the circuitry housing 12 to the electrical cable 16. The power connector 15 is configured to interact with an AC mains power supply, for example via a mains socket, to provide electrical current to the haircare appliance 10 in use.

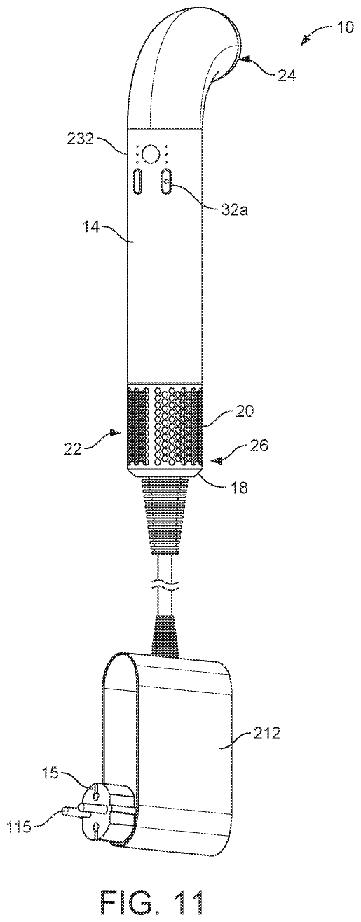

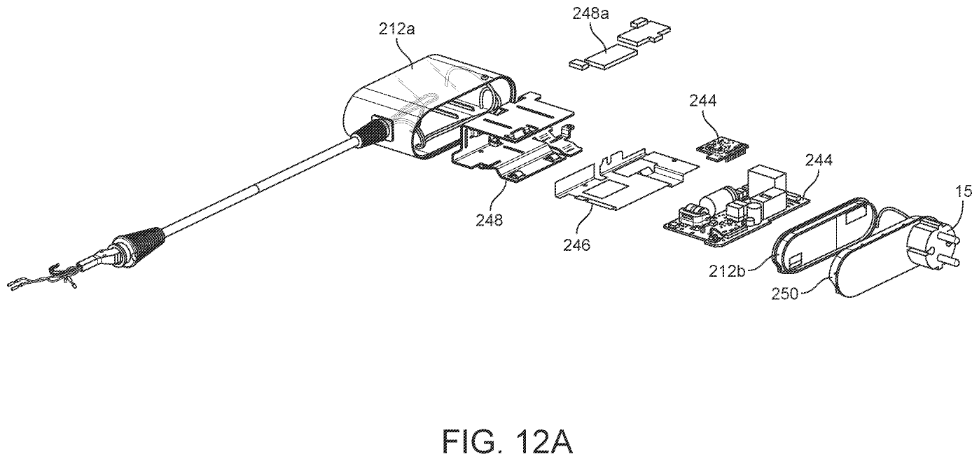

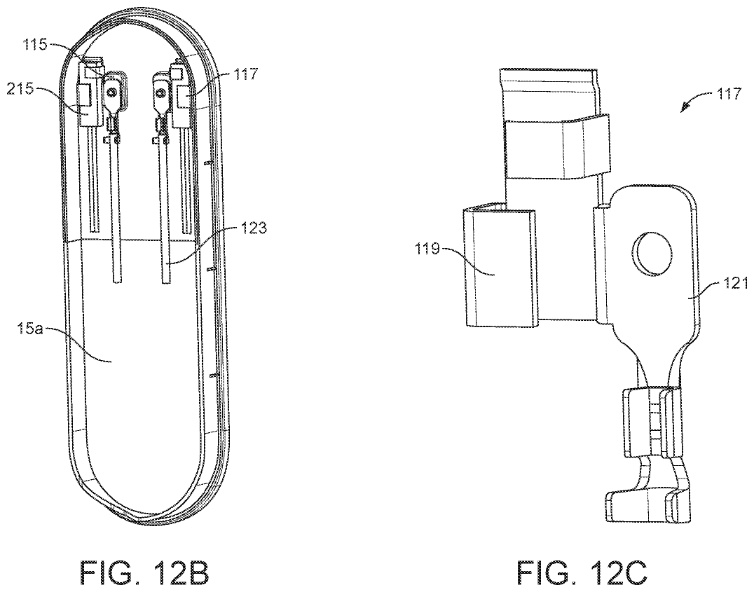

In an alternative embodiment shown in FIGS. 11 and 12, the circuitry housing 212 is integrally formed with the power connector 15. In this particular version, the power connector 15 is not formed as a unitary part of the circuitry housing 212, rather it is a separate part allowing for different power connectors to be used dependent on the territory the appliance is to be used in.

The circuitry housing 212 has a plug sleeve 212a and a plug end wall 212b and houses a number of components including a PCB assembly 244, insulation 246, a heat sink 248 and thermal pads 248a. The power connector 15 is mounted onto an end cap assembly 250 which is glued onto the plug end wall 212b to forma sealed unit.

In one embodiment, shown in FIGS. 12b and 12c, the power connector 15 additionally comprises a temperature sensor. This is particularly advantageous when the power connector 15 forms part of the circuitry housing 212. The power connector 15 includes engagement pins 115 for connection to a domestic power supply, for example. This example has two engagement pins 115 and each one has a thermistor 215 adjacent a portion of the pin. In this example, the thermistors 215 are located on an inner surface 15a of the power connector 15. Each thermistor 215 is biased towards a respective engagement pin 115 so it can accurately measure a temperature of the respective engagement pin 115. The biasing may be using a shaped terminal 117 which houses a thermistor 215 in a first portion 119 and provides a connection terminal 121 between an engagement pin 115 to an internal lead 123. The shaped terminal 117 can be crimped around the thermistor 215 and an internal lead 123 and can be riveted or screwed to the engagement pins 215. Alternatively, the inner surface 15a of the power connector 15 may comprise ribs or a similar structure which pushes the respective thermistor 215 towards a respective engagement pin 115. A thermal grease may be applied between the respective thermistor 215 and respective engagement pin 115 to improve thermal contact.

The heater housing 14 defines a hollow, generally elongate, handle that is intended to be grasped by a user in use. As seen in FIG. 1, the heater housing 14 comprises a conical end portion 18 and a wall 20 extending upwardly from the conical end portion 18, such that a first end 22 of the heater housing 14 is generally cylindrical in form. The heater housing 14 has a second end 24 distal from the first end 22, and the heater housing 14 is curved such that the second end 24 is angled relative to the first end 22. An air inlet 26 is located at the first end 22 of the heater housing 14 on the wall 20, and takes the form of a plurality of apertures, for example in a mesh-like structure. An air outlet 28 is located at the second end 24, and comprises an aperture through which air may flow in use. The electrical cable 16 enters the heater housing 14 through an aperture 19 (see FIG. 10) formed in the conical end portion 18, for example in a circular base 21 of the conical end portion 18. A user interface 32 is formed on the wall 20, and may take the form of a plurality of buttons, a touchscreen, or a combination thereof.

Disposed within the heater housing 14 are a heater assembly 34, an airflow generator 36, a temperature sensor 38, a user interface controller 40, a DC-DC converter 42, and a first set of communications circuitry 44. The heater assembly 34 comprises two heater elements 46, heater drive circuitry 48, and a heater controller 50. The form of the heater drive circuitry 48 is dependent upon a desired control scheme of the heater assembly 34, as will be appreciated by a person skilled in the art, and hence the specific form of the heater drive circuitry 48 may vary depending upon the heater elements 46 used, for example. The heater controller 50 as discussed herein is configured to operate the heater drive circuitry 48 using a burst-fire control scheme, a phase angle control scheme, or a combination thereof, to control current flow to the heater elements 46. In such embodiments, the heater drive circuitry 48 typically comprises a plurality of TRIACs used to control current flow to the heater elements 46 depending on an output of the heater controller 50.

The heater controller 50 is coupled to the user interface controller 40, such that the heater controller 50 can react to desired settings input via the user interface 32 and control the heater drive circuitry 48 accordingly.

The heater drive circuitry 48 is electrically coupled to the power supply connector 15 by a pair of power supply wires 52 that extend within the electrical cable 16 and through the circuitry housing 12. In some embodiments an input filter (not shown), for example comprising a capacitor or the like, is disposed between the pair of power supply wires 52 and the power supply connector 15 within the circuitry housing 12. The pair of power supply wires 52 comprise a live wire and a neutral wire.

The heater controller 50 is configured to be powered by low voltage DC electrical power supplied by the DC-DC converter 42. The DC-DC-converter 42 is configured to receive a DC voltage from the circuitry housing 12, for example from an AC-DC converter 62 housed within the circuitry housing 12, and to step-down the received DC voltage to a voltage level appropriate for operation of the heater controller 50. The architecture of such a DC-DC converter may comprise any common DC-DC converter architecture, for example a common step-down or buck converter architecture including a switch, a diode, an inductor, and a capacitor. The DC-DC converter 42 is electrically coupled to the AC-DC converter 62 in the circuitry housing 12 via a pair of communication wires 54 that extend within the electrical cable 16. The pair of communication wires 54 are referred to as such as they also enable sending and receiving of communication signals between the circuitry housing 12 and the heater housing 14.

In particular, the heater controller 50 is configured to communicate with one or more microcontrollers disposed within the circuitry housing 12, as will be described hereafter. The heater controller 50 is configured to pass a communication signal to the first set of communications circuitry 44. The first set of communications circuitry 44 is configured to encode and inject a communication signal onto the pair of communication wires 54, and in some embodiments also to decode a communication signal received via the pair of communication wires 54.

The temperature sensor 38 comprises an RTD sensor positioned and configured to provide an indication of the temperature of the heater elements 46. The temperature sensor 38 is electrically coupled to a thermal protection circuit 66 disposed within the circuitry housing 12 by a pair of thermal protection circuit wires 56 that extend within the electrical cable 16.

The airflow generator 36 comprises an airflow generator capable of generating an airflow within the heater housing 14, from the air inlet 26 to the air outlet 28 in use. An example of an appropriate airflow generator 36 is a motor comprising a driven impeller. One such motor is the V9 Dyson Digital Motor of Dyson Technology Limited, details of which can be found in published PCT patent application WO2017098202A1, for example. Such a motor is a single-phase brushless permanent-magnet motor. The airflow generator 36 is electrically coupled to airflow generator control circuitry 60 disposed within the circuitry housing 12 by a pair of motor current wires 58 that extend within the electrical cable 16.

Disposed within the circuitry housing 12 are airflow generator control circuitry 60, an AC-DC converter 62, a second set of communications circuitry 64, a thermal protection circuit 66, and a relay 68.

The airflow generator control circuitry 60 comprises airflow generator drive circuitry 70 and an airflow generator controller 72. Specifics of the airflow generator drive circuitry 70 depend on the airflow generator 36 used, but where the airflow generator 36 comprises a brushless permanent-magnet motor, such as the V9 Dyson Digital Motor of Dyson Technology Limited, the airflow generator drive circuitry 70 comprises a plurality of switches in the form of FETs arranged in a bridge formation.

Switches may be considered as relatively large electronic components. By locating the airflow generator drive circuitry within the circuitry housing 12, as opposed to within the heater housing 14, the heater housing 14 may be made smaller and/or lighter, or alternatively space may be made available within the heater housing 14. This does, however, necessitate use of the pair of motor current wires 58 to deliver phase current to the airflow generator 36 within the heater housing 14.

As briefly mentioned above, the V9 Dyson Digital Motor of Dyson Technology Limited is a single-phase motor. Use of a single-phase motor may reduce the number of wires required to extend from the circuitry housing 12 to the heater housing 14 compared to, for example a similar arrangement where a three-phase motor is utilised as the airflow generator 36 within the heater housing 14. Fewer wires may reduce a thickness of the electrical cable 16, which may provide increased flexibility and range of motion when the heater housing 14 is grasped by a user in use. This may provide an improved user experience.

That being said, it will be appreciated that a three-phase motor may still be used to obtain a smaller and/or lighter heater housing 14, albeit at the cost of an electrical cable 16 of reduced flexibility.

The V9 Dyson Digital Motor of Dyson Technology Limited is also controlled using what is known as a “sensorless” control scheme, ie a control scheme that estimates a position of the rotor of the motor without using a position sensor such as a Hall sensor. A “sensorless” control scheme may calculate a rotational position of the rotor, and hence also impeller, of the motor using current and/or voltage values communicated to the airflow generator control circuitry over the pair of motor current wires 58. This may reduce the number of wires required compared to, for example, a similar arrangement that utilises a Hall sensor to calculate rotor position, and, as discussed above, fewer wires may reduce a thickness of the electrical cable 16, which may provide increased flexibility and range of motion when the heater housing 14 is grasped by a user in use. This may provide an improved user experience.

Details of appropriate “sensorless” control schemes will not be discussed herein for the sake of brevity, but a suitable “analog sensorless” control scheme is disclosed in published PCT patent application WO2013132247A1, whilst details of an appropriate “digital sensorless” control scheme can be found in GB patent application no. 1904290.2.

The airflow generator drive circuitry 70 is configured to supply DC current to the airflow generator 36 via the pair of motor current wires 58, with the airflow generator drive circuitry 70 controlled by the airflow generator controller 72, which may comprise any appropriate microcontroller. The AC-DC converter 62 comprises a rectifier, for example a diode bridge rectifier, and is coupled to the power connector 15 such that the AC-DC converter 62 is coupled to the AC mains power supply in use. The AC-DC converter 62 supplies the airflow generator drive circuitry 70 with DC current, and also supplies DC current to the DC-DC converter 42 via the pair of communication wires 54.

The airflow generator controller 72 is communicatively coupled to the heater controller 50 via the pair of communication wires 54, and the second set of communications 64 is configured to decode a communication signal received via the pair of communication wires 54, and in some embodiments also to encode and inject a communication signal onto the pair of communication wires 54. As the pair of communication wires 54 are used both to transfer electrical power from the AC-DC converter 62 to the DC-DC converter 42 and to provide communication signals between the heater controller 50 and the airflow generator controller 72, the number of wires extending within the electrical cable 16 may be reduced compared to, for example, a similar arrangement where separate pairs of power wires and communication wires are utilised. Fewer wires may reduce a thickness of the electrical cable 16, which may provide increased flexibility and range of motion when the heater housing 14 is grasped by a user in use. This may provide an improved user experience.

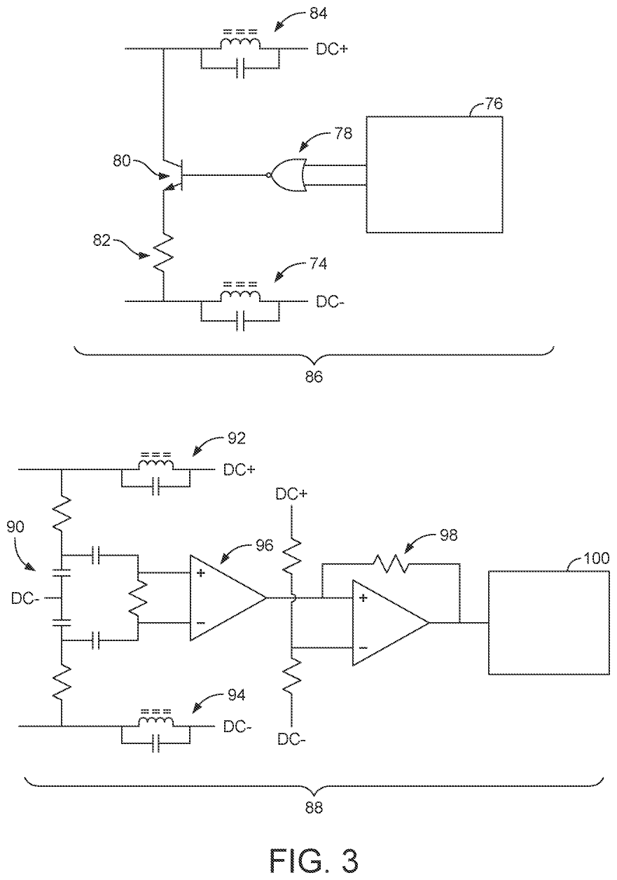

To achieve communication between the heater controller 50 and the airflow generator controller 72, the haircare appliance 10 utilises carrier modulated low voltage differential signalling. In this method, a controller modulates a carrier with data, and a signal is injected onto a low voltage transport wire-pair differentially. Circuitry at the other end of the transport wire-pair filters the signal, performs differential extraction, and demodulates the signal. Appropriate circuitry for the transmission and receipt of low voltage differential signals, for example embodiments of the first 44 and second 64 sets of communications circuitry are shown in FIG. 3.

As seen in FIG. 3, transmission circuitry 74 of the first 44 and second 64 sets of communication circuitry comprises a controller 76, a NOR gate 78, a transistor 80, a resistor 82, and first 84 and second 86 filters. In some embodiments the controller 76 may comprise a separate controller to the heater controller 50, whereas in other embodiments the heater controller 50 may be used as the controller 76 of the transmission circuitry 74. The controller 76 generates a carrier signal, in this case having a frequency of around 980 kHz, and also generates data to be sent using universal asynchronous receiver-transmitter (UART) hardware. The data modulates the carrier signal on and off, eg via on-off-keying (OOK), and the gate of the transistor 80 is controlled by the output of the NOR gate 78 to inject a communication signal onto the pair of communication wires 54. The resistor 82 is used to set the amplitude of the communication signal, whilst the first 84 and second 86 filters prevent the communication signal from being passed to the power system within the heater housing 14, ie prevent the communication signal from being passed to the DC-DC converter 42. As shown in FIG. 3 the first 84 and second 86 filters each comprise a capacitor connected in parallel with an inductor.

Receiving circuitry 88 of the first 44 and second 64 sets of communication circuitry comprises a low pass filter 90, first 92 and second 94 power filters, extraction circuitry 96, demodulation circuitry 98, and a controller 100. The low pass filter 90 comprises a plurality of capacitors for removing high frequency noise from the signal, whilst the first 92 and second 94 power filters prevent the communication signal from being passed to the power system within the circuitry housing 12, ie prevent the communication signal from being passed to the AC-AC converter 62. As shown in FIG. 3 the first 92 and second 94 power filters each comprise a capacitor connected in parallel with an inductor. It will be appreciated that the power filters 92,94 may not be necessary in embodiments where the transmission circuitry 74 has the first 84 and second 86 filters, and vice versa, such that only one of the transmission circuitry 74 and the receiving circuitry 88 has appropriate filters to prevent the communication signal from being passed to the power system of the haircare appliance 10.

The extraction circuitry 96 comprises a comparator for extracting the differential signal back to a ground referenced signal, whilst the demodulation circuitry 98 comprises a comparator and a plurality of resistors for removing the carrier frequency from the signal. The controller 100 then receives data via UART hardware. In some embodiments the controller 100 may comprise a separate controller to the airflow generator controller 72, whereas in other embodiments the airflow generator controller 72 may be used as the controller 100 of the receiving circuitry 88.

It will be appreciated that in some embodiments, for example where two-way communication is desired between the heater controller 50 and the airflow generator controller 72, the first 44 and second 64 sets of communication circuitry may each comprise transmission circuitry 74 and receiving circuitry 88, whilst in other embodiments, for example where only one-way communication is desired from the heater controller 50 to the airflow generator controller 72, the first set of communication circuitry 44 may comprise transmission circuitry whilst the second set of communication circuitry 64 may comprise receiving circuitry 88.

As previously mentioned, the thermal protection circuit 66 is electrically coupled to the temperature sensor 38 by a pair of thermal protection circuit wires 56 that extend within the electrical cable 16 from the circuitry housing 12 to the heater housing 14. The thermal protection circuit 66 is also electrically coupled to the relay 68, which is located on the live wire of the pair of power supply wires 52. By removing the thermal protection circuit 66 and the relay 68 from the heater housing 14, a smaller and/or lighter heater housing 14 may be achieved. Furthermore, an RTD sensor may be comparatively smaller than, for example, a thermal fuse typically used in haircare appliances, and so use of an RTD sensor may provide a smaller and/or lighter heater housing 14.

The thermal protection circuit 66 comprises any appropriate circuitry for receiving a resistance value of the RTD temperature sensor 38, and controlling the relay 68 in response to the resistance value of the RTD temperature sensor 38. In such a manner, supply of current from the mains power supply to the heater elements 46 may be interrupted by the relay 68 in response to a resistance value of the RTD temperature sensor 38, for example where an over-temperature event occurs.

The exact architecture of the thermal protection circuit 66 may vary provided that it is sufficient to monitor the value provided by the RTD temperature sensor 38 and control the relay 68 in response. For example, the thermal protection circuit 66 may provide a comparator and a latch set in response to the comparator, with the latch controlling the relay 68. The comparator may compare a sensed value from the RTD temperature sensor 38 to a pre-determined limit, and set the value of the latch based on the comparison. The latch value may then control drive circuitry for opening and closing the relay 68. In some examples the relay 68 may comprise a one-time relay, such that opening of the relay requires maintenance of the haircare appliance 10, or indeed replacement of the haircare appliance 10.

In use, the heater controller 50 is able to control current flow to the heater elements 46, from the pair of power supply wires 52, using the heater drive circuitry 58 in response to commands input by a user using the user interface 32 and communicated to the heater controller 50 via the user interface controller 40, for example to raise or lower the temperature of the heater elements 46. The heater controller 50 is able to communicate with the airflow generator controller 72 over the pair of communication wires 54, with the airflow generator controller 72 controlling the airflow generator drive circuitry 70 to control flow of current to the airflow generator 36 along the pair of motor current wires 58, for example to increase or decrease airflow through the heater housing 14. Thus the heater controller 50, which may be considered a master controller for the haircare appliance 10, may be utilised to control both temperature and airflow provided by the haircare appliance 10 in use.

The RTD temperature sensor 38 is able to feedback the temperature of the heater elements 46, for example indirectly via a resistance measurement, to the thermal protection circuit 66 via the pair of thermal protection circuit wires 56, with the thermal protection circuit 66 controlling the flow of current from the mains power supply to the heater drive circuitry 58 along the pair of power supply wires 52.

As previously mentioned, removing the airflow generator control circuitry 60, the AC-DC converter 62, the thermal protection circuit 66, and the relay 68 from the heater housing 14, and locating these components in the circuitry housing 12, may enable the heater housing 14, which is intended to be grasped by a user in use, to be smaller and lighter, which may provide an improved user experience.

However, locating the above-mentioned components in the circuitry housing as opposed to the heater housing 14 may require a number of electrical connections to extend from the circuitry housing 12 to the heater housing 14, in the form of wires housed within the electrical cable 16. As the number of wires housed within the electrical cable 16 increases, so does the thickness of the electrical cable 16, and a thicker electrical cable 16 may be more rigid than a thinner electrical cable 16. A more rigid electrical cable 16 may provide less range of motion between the circuitry housing 12 and the heater housing 14, which may negatively impact a user experience when using the haircare appliance 10.

By utilising any or any combination of combined power and signalling wires, a single-phase motor, and a motor that utilises a “sensorless” control scheme, the number of wires needed to achieve the functionality described above may be kept to a minimum.

Indeed, by utilising the pairs of wires 52,54,56,58 and electrical connections described above, it has been found that the functionality described herein can be achieved whilst having no more than 8 wires extending from the circuitry housing 12 to the heater housing 14 in the electrical cable 16. This has been found to provide both the desired functionality and the flexibility of electrical cable 16 needed to provide an adequate user experience.

In view of the relatively large number of electrical connections extending from the circuitry housing 12 to the heater housing 14, in the form of the pairs of wires 52,54,56,58 housed in the electrical cable 16, the electrical connections must be securely held to avoid failure of the haircare appliance 10 in use.

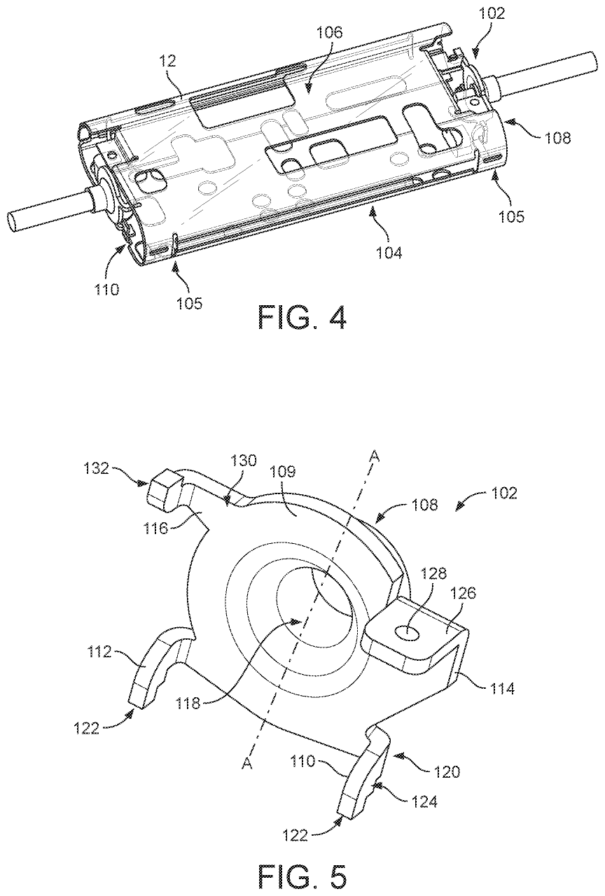

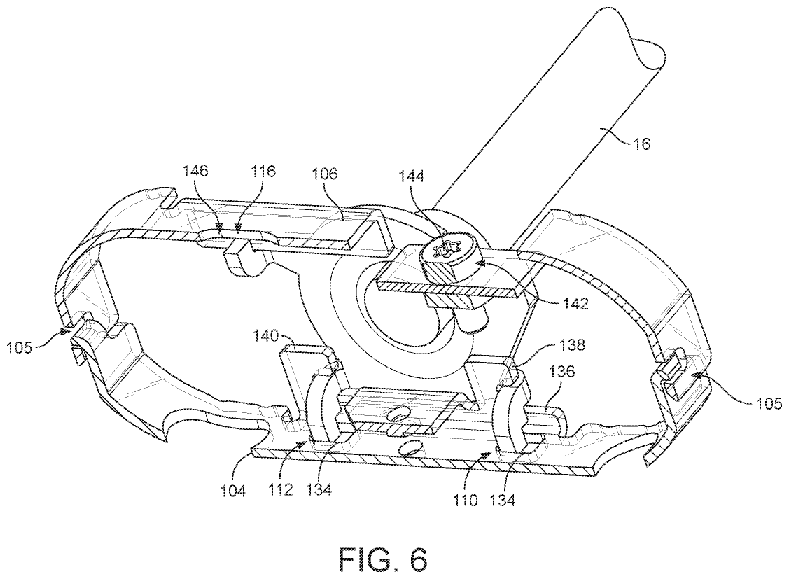

One such way of securely holding the electrical connections is to provide an attachment member 102 that attaches the electrical cable 16 to the circuitry housing 12, as shown in FIGS. 4 and 6.

As seen in FIG. 4, the circuitry housing 12 is generally cuboidal in form, although with curved vertices, such that the circuitry housing 12 has a first, lower, side 104 and a second, upper, side 106 opposite to the first side 104. Third 103 and fourth 107 sides of the circuitry housing 12 are defined by end faces extending between the first 104 and second 106 sides. The first 104 and second 106 sides of the circuitry housing 12 are formed as separate components held together by corresponding clips 105, with the third 108 and fourth 110 sides added to the circuitry housing 112 once the first 104 and second 106 sides have been clipped together and the attachment member 102 has been engaged with the circuitry housing 12. As will be described hereafter, the attachment member 102 engages both the first 104 and second 106 sides of the circuitry housing 12 to provide a secure connection between the electrical cable 16 and the circuitry housing 12.

The attachment member 102 is shown in isolation in FIG. 5. The attachment member 102 comprises a main body 108, and first 110, second 112, third 114 and fourth 116 arms extending from the main body 108. The main body 108 is generally conical in form with a circular base 109, and a bore 118 is disposed centrally on the main body 108, ie centrally on the circular base 109. The bore 118 is shaped and dimensioned to receive the electrical cable 16 therein, for example via a friction fit sufficient to retain the electrical cable 16 within the bore 118 when a force is applied to the electrical cable 16 in use.

Each of the first 110, second 112, third 114 and fourth 116 arms are formed integrally with the main body 108, such that the attachment member 102 comprises a monolithic structure. The attachment member 102 is formed of a metallic material, which may allow for both rigidity and thermal conductivity.

Each of the first 110 and second 112 arms comprises a similar structure, and extends outwardly from the main body 108 in a lateral direction in a plane parallel to the bore 118 as seen in FIG. 5, before extending in a direction orthogonal to the main body 108 and curving downwardly to again extend in a plane parallel to the bore 118 as seen in FIG. 5. Thus each of the first 110 and second 112 arms has a respective first end 120 attached to the main body 108, and a respective second end 122 which is a free end and can engage with the first side 104 of the circuitry housing 12.

A first side of each of the first 110 and second 112 arms comprises a smooth curve, whilst a second opposing side, a lower side as seen in FIG. 5, of each of the first 110 and second 112 arms comprises a respective engagement feature in the form of a step 124 shaped to engage a lip 136 extending upwardly from the first side 104 of the circuitry housing 12, as seen in FIG. 6. The first side of each of the first 110 and second 112 arms is configured to engage a respective engagement clip 138,140 extending from the first side 104 of the circuitry housing 12, as seen in FIG. 6.

As seen in FIG. 5, the bore 118 comprises a central axis A-A extending through a centre-point of the bore 118, with the first arm 110 located on a first side of the bore 118, ie a first side of the central axis A-A, and the second arm 112 located on a second opposing side of the bore 118, ie a second side of the central axis A-A. The first 110 and second 112 arms are spaced equidistantly from the central axis A-A, which may provide an even distribution of forces when the attachment member 102 is engaged with the circuitry housing 12.

The third arm 114 extends outwardly from the main body 108 in a lateral direction in a plane parallel to the bore 118 as seen in FIG. 5, before extending in a direction orthogonal to the main body 108. The third arm 114 has a planar portion 126 which is substantially parallel to the second side 106 of the circuitry housing 12 when the attachment member 102 is engaged with the circuitry housing. The planar portion 126 comprises a through-hole 128 for receiving a fastener 144 to engage the third arm 114 with the second side 106 of the circuitry housing 12.

The third arm 114 is located on the main body 108 substantially opposite to the first arm 110, with the through-hole 128 located substantially opposite to the second end 122 of the first arm 110. In such a manner regions of engagement of the first 110 and third 114 arms with the circuitry housing 12 may be located substantially opposite one another, as will be discussed in more detail hereafter.

Similarly to the first 110 and second 112 arms, the fourth arm 116 extends outwardly from the main body 108 in a lateral direction in a plane parallel to the bore 118 as seen in FIG. 5, before extending in a direction orthogonal to the main body 108 and curving upwardly to again extend in a plane parallel to the bore 118 as seen in FIG. 5. Thus the fourth arm 116 has a first end 130 attached to the main body 108, and a second end 132 which is a free end and can engage with the second side 106 of the circuitry housing 12.

The third arm 114 is located on a first side of the bore 118, ie a first side of the central axis A-A, and the fourth arm 116 is located on a second opposing side of the bore 118, ie a second side of the central axis A-A. The third 114 and fourth 116 arms are spaced equidistantly from the central axis A-A, which may provide an even distribution of forces when the attachment member 102 is engaged with the circuitry housing 12.

The fourth arm 116 is located on the main body 108 substantially opposite to the second arm 112, with the second end 132 of the fourth arm 116 located substantially opposite to the second end 122 of the second arm 112. In such a manner regions of engagement of the second 112 and fourth 116 arms with the circuitry housing 12 may be located substantially opposite one another, as will be discussed in more detail hereafter.

In the manner described above, the first 110, second 112, third 114 and fourth 116 arms are distributed about the periphery of the main body 108, and, when engaged with the circuitry housing 12, may provide a secure engagement that inhibits separation of the attachment member 102, and hence the electrical cable 16 held within the bore 118, from the circuitry housing 12 in the presence of an applied force in use, for example a force applied in a longitudinal direction of the electrical cable 16.

The engagement between the attachment member 102 and the circuitry housing 12 can be seen in FIG. 6.

The first side 104 of the circuitry housing 12 has two locating features in the form of apertures 134 within which the second ends 122 of the first 110 and second 112 arms are respectively received. In the presence of an applied force in a plane parallel to the first side 104 of the circuitry housing 12, the second ends 122 of the first 110 and second 112 arms engage with the periphery of the apertures 134 to inhibit removal of the attachment member 102, and hence the electrical cable 16, from the circuitry housing 12.

The first side 104 of the circuitry housing 12 also comprises a lip 136 extending upwardly from the circuitry housing, with the lip 136 defining a flat surface that engages with the steps 124 of the first 110 and second 112 arms. In the presence of an applied force in a plane parallel to the first side 104 of the circuitry housing 12, the engagement of the steps 124 with the lip 126 inhibits removal of the attachment member 102, and hence the electrical cable 16, from the circuitry housing 12.

The first side 104 of the circuitry housing further comprises first 138 and second 140 engagement clips that engage upper surfaces of the first 110 and second 112 arms as seen in FIG. 6. The first 138 and second 140 engagement clips are generally L-shaped in form, and in the presence of an applied force in a plane orthogonal to the first side 104 of the circuitry housing 12, for example a force applied in a direction between the first side 104 and the second side 106 of the circuitry housing 12, the engagement of the engagement clips 138,140 with the first 110 and second 112 arms inhibits removal of the attachment member 102, and hence the electrical cable 16, from the circuitry housing 12.

The second side 106 of the circuitry housing 12 comprises a through-hole 142 aligned with the through-hole 128 of the third arm 114 of the attachment member 102. A fastener 144 in the form of a screw extends through the through-holes 128,142 and acts to engage the second arm 112 of the attachment member 102 with the second side 106 of the circuitry housing 12. The fastener 144 inhibits removal of the attachment member 102, and hence the electrical cable 16, from the circuitry housing 12, in the presence of applied forces in both directions in planes parallel and orthogonal to the second side 106 of the circuitry housing 12. The through-holes 128,142 are aligned with one of the apertures 134 of the first side 104 of the circuitry housing 12, such that engagement of the first 110 and third 114 arms with respective first 104 and second 106 sides of the circuitry housing 12 are opposite one another.

The second side 106 of the circuitry housing 12 further comprises a locating feature in the form of an aperture 146 within which the second end 132 of the fourth arm 116 is received. In the presence of an applied force in a plane parallel to the second side 106 of the circuitry housing 12, the second end 132 of the fourth arm 116 engages with the periphery of the aperture 146 to inhibit removal of the attachment member 102, and hence the electrical cable 16, from the circuitry housing 12.

The aperture 146 of the second side 106 of the circuitry housing 12 is aligned with one of the apertures 134 of the first side 104 of the circuitry housing 12, such that engagement of the second 112 and fourth 116 arms with respective first 104 and second 106 sides of the circuitry housing 12 are opposite one another.

The engagement of the attachment member 102 with the circuitry housing 12 as described above may provide a secure engagement of the electrical cable 16 to the circuitry housing 12, which may ensure that the electrical connections held within the electrical cable, ie the pairs of wires 52,54,56,58, are securely held to avoid failure of the haircare appliance 10 in use.

As the first 110 and second 112 arms are engaged with the first side 104 of the circuitry housing 12, and the third 114 and fourth 116 arms are engaged with the second side 106 of the circuitry housing 12, forces may be evenly distributed between the first 104 and second 106 sides of the circuitry housing 12 in the presence of an applied force on the electrical cable 16, and hence on the attachment member 102, in use. This may be beneficial where, for example, the first 104 and second 106 sides of the circuitry housing are defined by separate components attached to one another.

The attachment member 102 described above may also create space within the circuitry housing 12 as the arms 110,112,114,116 extend from the main body 108 into the interior of the circuitry housing 12 to engage with the circuitry housing 12, whilst the main body 108 is located at a periphery of the circuitry housing 12.

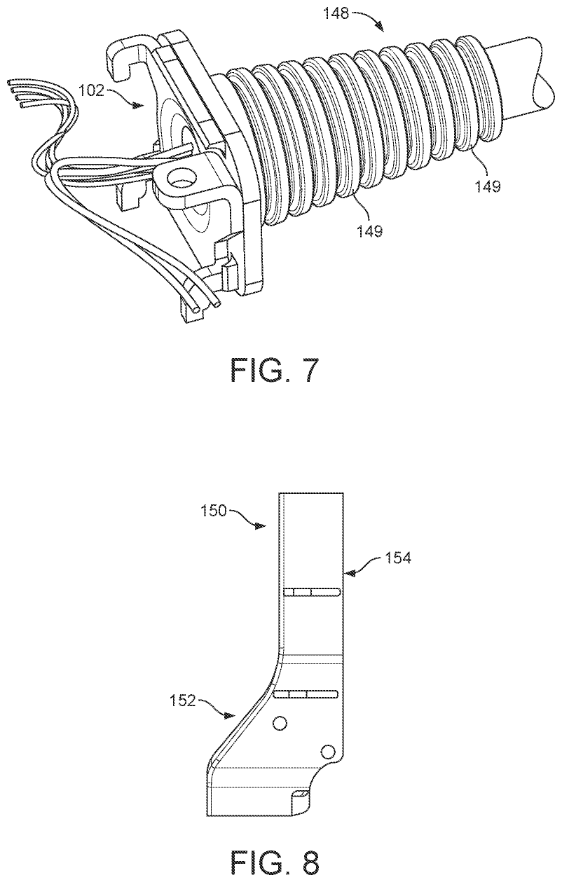

To further mitigate forces applied to the electrical cable 16 in use, a stress release feature 148 is overmoulded onto the attachment member 102, as shown in FIG. 7. The stress release feature 148 comprises a plurality of spaced apart ribs 149 which are each configured to deform and contact an adjacent rib 149 in the presence of an applied force to the electrical cable 16.

As mentioned above, in view of the relatively large number of electrical connections extending from the circuitry housing 12 to the heater housing 14, in the form of the pairs of wires 52,54,56,58 housed in the electrical cable 16, the electrical connections must be securely held to avoid failure of the haircare appliance 10 in use.

Another such way of securely holding the electrical connections is to provide a wire guide 150 that holds the pairs of wires 52,54,56,58 within the heater housing 14, as shown in FIG. 8.

As can be seen in FIG. 8, the wire guide 150 comprises a first portion 152 and a second portion 154, with the first portion 152 obliquely angled relative to the second portion 154. The wire guide 150 is overmoulded onto the pairs of wires 52,54,56,58, for example during manufacture, such that the wire guide 150, and hence the first 152 and second 154 portions, comprise a monolithic structure, and the pairs of wires 52,54,56,58 are securely held by the wire guide 150. The wire guide 150 may then be inserted into the heater housing 14 along with the pairs of wires 52,54,56,58, which may provide for ease of manufacture compared to, for example, an arrangement where wires of the pairs of wires 52,54,56,58 are individually inserted into apertures of a wire guide. The material of the wire guide 150 has a Shore A hardness in the region of 40-60, preferably around 50. This may provide a reasonable compromise between rigidity and flexibility for the wire guide 150. For example, a relatively rigid wire guide 150 may be problematic for insertion of the wire guide 150 into the heater housing 14 during manufacture, whilst risk of separation of wires from the wire guide 150 may be increased where the wire guide 150 is relatively flexible.

The wire guide 150 is shaped such that there is a curved transition between the first 152 and second 154 portions, which may provide the wire guide 150 with greater structural integrity than, for example, a wire guide comprising a sharp transition between the first 152 and second 154 portions.

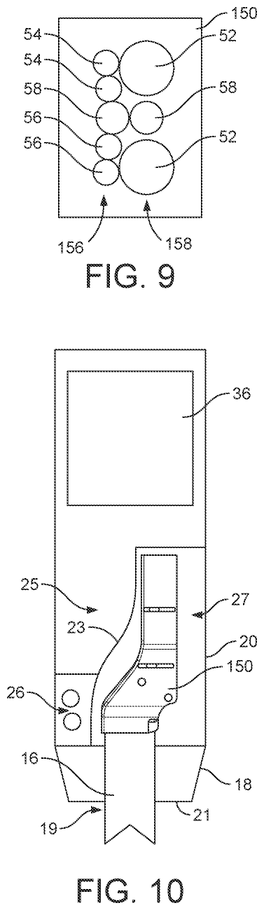

The wire guide 150 holds the pairs of wires 52,54,56,58 in first 156 and second 158 rows, as can be seen in FIG. 9, which is a schematic view illustrating an end of the wire guide 150. The first row 156 comprises the pair of communication wires 54, the pair of thermal protection circuit wires 56, and one of the pair of motor current wires 58. The second row 158 comprises the pair of power supply wires 52 and the other one of the pair of motor current wires 58. Each wire of the pair of communication wires 54 and the pair of thermal protection circuit wires 56 has a diameter of around half the diameter of each wire of the pair of power supply wires 52, such that the first 156 and second 158 rows have substantially the same length. This may provide a relatively compact array for the pairs of wires 52,54,56,58, which may reduce space taken up by the wire guide 150 within the heater housing 14, thereby enabling more space for, for example, an airflow channel within the heater housing 14.

The wires of the pair of communication wires 54 are disposed adjacent one another in the first row 156, and the wires of the pair of thermal protection circuit wires 56 are disposed adjacent one another in the first row 156, with the one of the pair of motor current wires 58 intermediate the pair of communication wires 54 and the pair of thermal protection circuit wires 56 in the first row 156. The other of the pair of motor current wires 58 is located intermediate wires of the pair of power supply wires 52 in the second row 158, with the wires of the pair of motor current wires 58 adjacent to one another between the first 156 and second 158 rows. The orientation of wires within the heater housing 14 will, of course, depend on the layout of components within the heater housing 14, but a compact array of wires has been achieved in the manner described above.

The location of the wire guide 150 within the heater housing 14 is shown schematically in FIG. 10.

As mentioned above, the heater housing 14 defines a hollow, generally elongate, handle that is intended to be grasped by a user in use. The heater housing 14 comprises a conical end portion 18 and a wall 20 extending upwardly from the conical end portion 18, such that a first end 22 of the heater housing 14 is generally cylindrical in form. An aperture 19 is formed centrally on a base 21 of the conical end portion 18, and the electrical cable 16, and hence the pairs of wires 52,54,56,58, extends through the aperture into the interior of the heater housing 14. The heater housing 14 comprises an internal wall 23 that splits the interior of the heater housing 14 into an airflow path 25 extending from the air inlet 26 and a channel 27 sealed from the airflow path 25.

The wire guide 150 is disposed in the channel 27, such that the wire guide 150 is not located within the airflow path 25. This may provide greater flexibility in choice of shape for the wire guide 150, and may also improve airflow characteristics through the airflow path 25. The wire guide 150 is also disposed in the channel 27 such that the first portion 152 of the wire guide 150 extends in a direction from the aperture, and hence also from the base 21, toward the wall 20. The second portion 154 of the wire guide 150 extends parallel to the wall 20. In such a manner, the wire guide 150 guides the pairs of wires 52,54,56,58 from the aperture 19 toward the wall 20. This may create space within the heater housing 14 for the airflow path 25, and may allow for the airflow path 25 to have a more desirable shape than, for example, a space provided were the wire guide 150 to extend solely upwardly from the aperture 19, ie orthogonally from the plane of the aperture 19. The wire guide 150 may also inhibit separation of the pairs of wires 52,54,56,58 from the heater housing 14, for example when a force is applied in a direction orthogonal to the plane of the aperture 19 in use, for example a pulling force applied to the pairs of wire 52,54,56,58 in a direction away from the heater housing 14. For example, the wire guide 150 may engage with the end portion 18, for example the base 21, of the heater housing 14 to inhibit separation of the plurality of wires 52,54,56,58 from the heater housing 14.

In the embodiment of FIG. 10, the wire guide 150 engages with the end portion 18 via a clamp 160. The clamp 160 is annular in form, and has a diameter substantially corresponding to a width of the wire guide 150, or alternatively slightly less than a width of the wire guide 150, such that the wire guide 150 is held within the clamp 160. The clamp 160 then engages the end portion 18 about the periphery of the aperture 19 via an annular abutment portion 162 to inhibit separation of the plurality of wires 52,54,56,58 from the heater housing 14.

The haircare appliance 10 described above may provide a lighter and/or smaller, and hence more user-friendly, heater housing 14, whilst at the same time providing secure electrical connections between the circuitry housing 12 and the heater housing 14, without compromising on relative motion between the heater housing 14 and the circuitry housing 12 when the heater housing 14 is grasped and moved by a user in use.

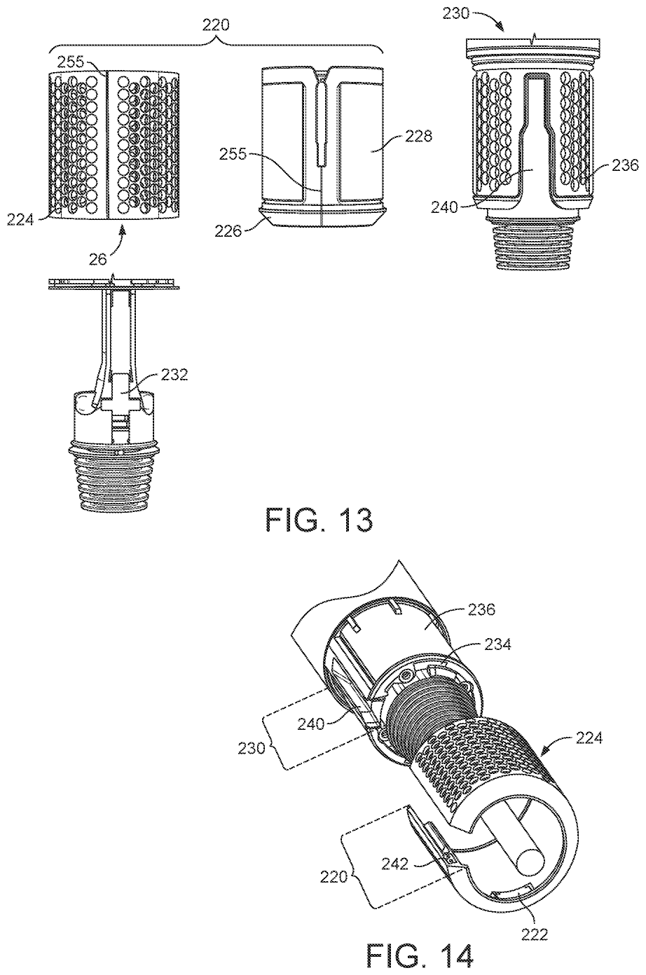

Further features of the haircare appliance 10 will now be discussed. The air inlet 26, comprises a plurality of apertures and forms part of a filtration structure. Referring now to FIG. 13, the air inlet 26 is formed of a removable part 220 and a fixed part 230. The fixed part 230 comprises an array of apertures 236 around 2-4 mm in diameter and acts as a finger guard preventing access to the internal parts of the appliance. The removable part 220 provides the main filtration media. In order to protect the internal components of the appliance from ingress of material when in use, the appliance can not be switched on whilst the removable part 220 of the filtration structure is absent from the appliance 10. The fixed part 230 can be formed integrally with the wall 20 as shown in FIG. 13 or can be formed separately and then attached to the wall 20 or an internal structure located within the heater housing.

The skilled person will appreciate there are a number of ways of preventing the appliance from being turned on and in this example, a reed switch 232 is provided adjacent the fixed part 230 inside the wall 20. The removable part 220 is provided with magnets 222 which connect the removable part to the fixed part 230. The fixed part 230 has corresponding magnetisable material 234.

The removable part 220, in this embodiment, can be split into an outer grille 224 and an intermediate layer 226 as this facilitates cleaning of the depth loading media 228 provided in the intermediate layer 226, such cleaning may be done by hand or in a dishwasher for example. In order to remove the removable part 220 of the filtration structure from the electrical cable 16, the removable part 220 is manufactured with a split line 225. Thus, once the removable part 220 is removed from the fixed part 230 by sliding the removable part 220 away from the heater housing 16, the removable part 220 may be opened along the split line 225 form a C-shaped structure which can be removed from the electrical cable 16.

The outer grille 224 is essentially a sleeve which slides over the intermediate layer 226. If the outer grille 224 alone is presented to the fixed part 230 it has no means to engage with the fixed part 230 without the intermediate player 226.

In order to return the removable part 220 to the filtration structure, it is opened, placed around the electrical cable 16, then closed and slid onto the fixed part 230. In this embodiment, the removable part 220 is held closed using a pair of magnets 242 one provided either side of the split line 225 and these are the accommodated within a channel 240 on the fixed part 230. This is explained in greater detail in International Patent Publication Number WO2019/077301 and International Patent Application Number PCT/GB2021/050777.

The reed switch 232 interacts with either the magnetic coupling retaining the removable part on the appliance and/or the magnetic coupling around the split line 225. Thus, when one or both of these couplings is proximate to the reed switch 232, the switch within the reed switch 232 closes completing the electrical circuit in the appliance enabling a user to turn on the appliance. Removal of the removable part 220 of the filtration structure causes the reed switch to open as the magnetic coupling is broken or the magnetic force removed, which breaks the circuit, preventing the appliance from working.

In this embodiment, the fixed part 230 of the filter is integrally formed as part of the wall 20. As the skilled person will appreciate, the fixed part 230 could be formed as a separate part and attached to the wall 20 by screws, glue etc. . . .

The heater housing 14 has internal features including an inner wall 23 which is formed as a clam shell and provides various locating features for components located within the wall 20. Within the inner wall 23 is a fluid flow path 290; air is drawn into the air inlet 26 by the flow generator 36 located within the inner wall 23. The inner wall 23 is formed from two parts, a main part 180 and a clam shell 190, components such as the flow generator 36 are located within the main part 180 and then the clam shell 190 is attached to the main part 180 securing those components in place within the appliance.

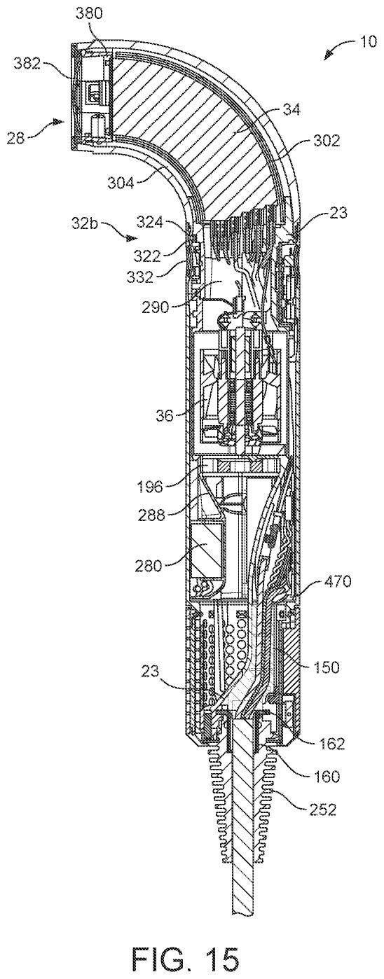

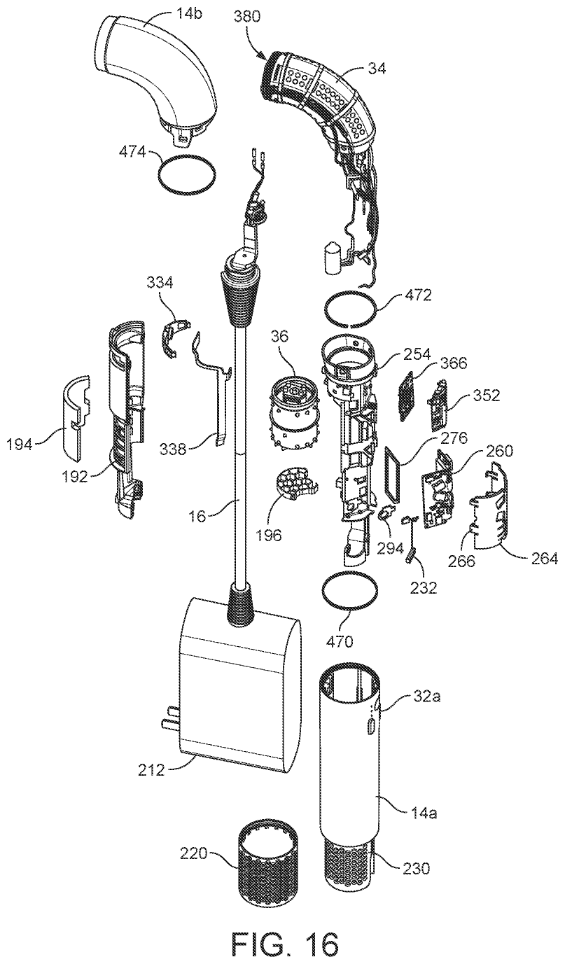

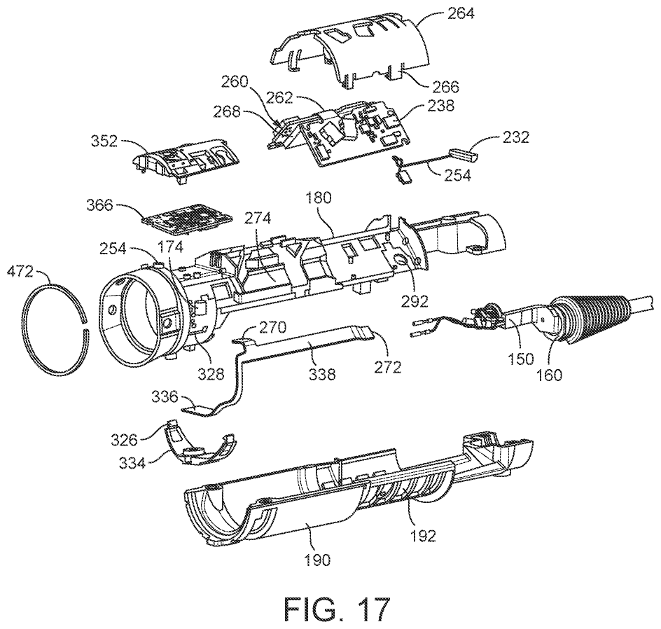

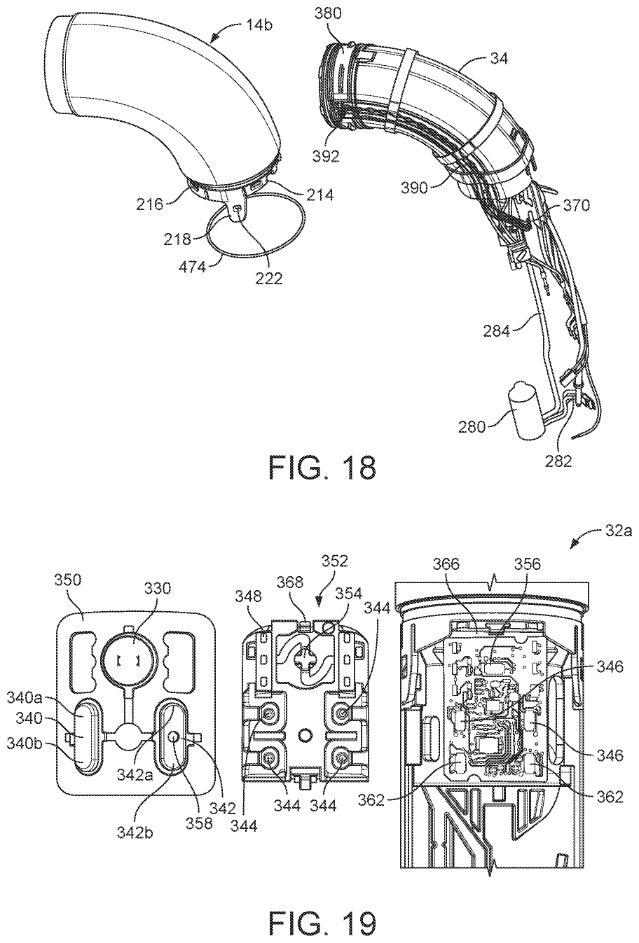

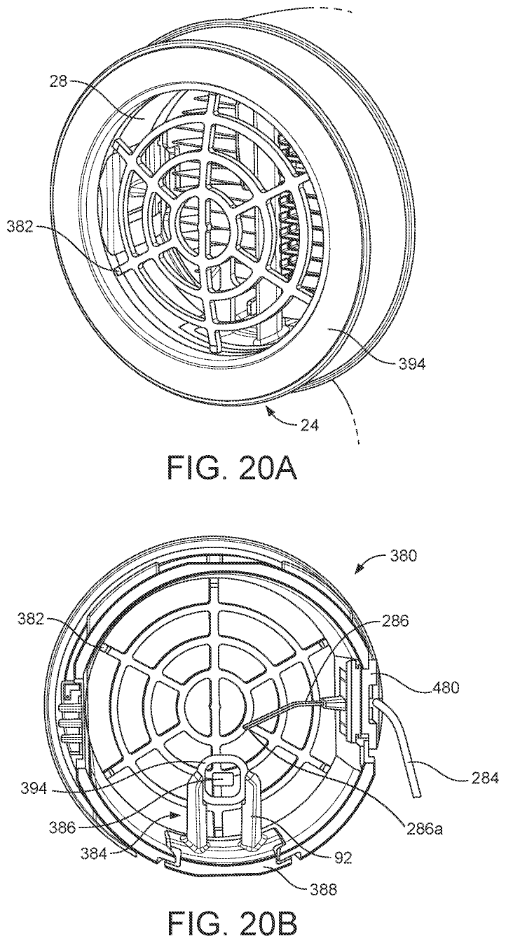

Referring now to FIGS. 15 to 18, the heater housing 14 is manufactured in two parts, a first part 14a which is tubular in shape and forms the handle intended to be grasped by a user in use, and a second part 14b which is arch shaped and houses the heater assembly 34. The second part 14b includes a number of locating features which, in this embodiment attach to the inner wall 23, but the skilled person could conceive of the second part 14b attaching to the first part 14a. For strength around the region where the first part 14a and the second part 14b of the heater housing are attached, the main part 180 of the inner wall 23 includes a collar 182 which extends all the way around the fluid flow path 290 providing a single part for the second part 14b of the heater housing to engage with. The collar 182 provides a single moulded part for the second part 14b of the heater housing to join to giving a more rigid connection.

The second part 14b of the heater housing 14 comprises a collar 214 which includes six locating features, four recesses 216 which are circumferentially spaced around the collar 214 and two tabs 218 which extend further within the first part 14a of the heater housing 14 to provide more stability. The four recesses 216 cooperate with four engaging tabs 182 on the main part 180 and the two tabs 218 include apertures 222 which cooperate with clips 174 provided on the inner wall 23. When the second part 14b is correctly aligned with the inner wall 170, the four engaging tabs 172 and the two clips 174 sit within the four recesses 216 and the two apertures 222 respectfully. When assembled, the space between the first part 14a and the inner wall 23 is insufficient to allow movement of the respective tabs and clips out of their respective recesses and apertures.

Returning now to the air inlet, and FIG. 15, the wire guide 150 engages with inner wall 23 and the end portion 18 via a clamp 160. The clamp 160 is annular in form, and has a diameter substantially corresponding to a width of the wire guide 150, or alternatively slightly less than a width of the wire guide 150, such that the wire guide 150 is held within the clamp 160. The clamp 160 then engages the end portion 18 about the periphery of the aperture 19 via an annular abutment portion 162 to inhibit separation of the plurality of wires 52,54,56,58 from the heater housing 14.

The electrical cable 16 enters the heater housing 14 through an aperture 19 (see FIG. 10) formed in the conical end portion 18. In order to stop excessive bending and strain on the wire 16 at this junction, it is overmoulded with a stress relief feature 252 similar to that on the circuitry housing 12. The stress relief feature 252 extends over the clamp 160 and extends along the cable 16 tapering away from the heater housing 14.

At the upstream end of the wire guide 150, the pairs of wires 52,54,56,58 exit from the wire guide 150 between the inner wall 23 and the wall 20 and are connected to a PCB 260. This PCB has a number of functions, it provides connection points for wires 52, 54, 56, 58 from the cable 16 enabling the different wires to be separated for routing through the appliance; it houses a pressure sensor which measures the pressure within the fluid flow path 290 via a pressure sensing aperture 292 formed within the inner wall 23. A seal 294 is formed around the pressure sensing aperture 292 to prevent fluid transfer from the fluid flow path 290 into the cavity between the inner wall 23 and the wall 20.

In addition, switches 268 for controlling power to the heater as part of the heater drive circuitry 48 are provided on PCB 260. The switches 268 are triacs and one triac is provided to switch the power for each heater element. This enables the temperature of the air flowing from the fluid outlet 28 to be controlled. In this example, three triacs are used as there are three heater tracks (not shown). The switches 268 are open to the fluid flow path 290 to able heat transfer away from the switches 268. A seal 276 is formed around the switches 268 to stop any fluid transferring between the fluid flow path 290 and the area between the inner wall 23 and the wall 20.

A reed switch connection 238 is provided on the PCB 260 enabling a signal from the reed switch 232 to be connected via wiring 254 to the circuitry so the presence of the removable part 220 of the filter can be detected.

An ioniser connection is provided on the PCB 260, a pair of ioniser power supply wires 282 connect the PCB 260 to an ion generator 280 which in turn has an output lead 284 connecting to an ion emitter 286. In this example the ion emitter 286 is a needle however any sharp pointed surface or surfaces are suitable as the skilled person will be aware. The ion emitter 286 is located within the fluid flow path 290 near the air outlet 28. An emitter housing 480 secures the ion emitter 286 with respect to the inner wall 23. The emitter housing 480 is a grommet which slides into a correspondingly sized aperture in the inner wall 23, sealing the aperture to prevent fluid leakage from the fluid flow path 290. The emitter housing 480 covers and protects the connection between the output lead 284 and the ion emitter 286 as well as locating the end of the ion emitter 286 within the fluid flow path 290.

In this embodiment the ion emitter 286 is a rod needle and the point at the end is made using a lathe. The rod needle is bent accordingly to ensure that the emitter tip 286a is located within the optimized space envelope (with considerations of air flow profile and proximity to other materials). The distal end of the rod needle is stamped and punched to a flat sheet to allow soldering with the wiring connection i.e. the output lead 286. The emitter housing 480 is overmoulded following the soldering process. A suitable material for the emitter housing is a liquid crystal polymer (LCP) which has good thermal properties.

A bullet shaped hollow 288 having curved surfaces to minimise disturbance to air flowing within the inner wall 23 provides a housing for the ion generator 280. In this embodiment, this is provided upstream of the wire guide 150 and radially opposite although this is not essential. The output lead 284 is routed between the inner wall 23 and the wall 20.

The PCB 260 is formed from two parts which are hinged together via either a flexible electrical connector or a machined rigid piece of PCB 262 both achieve the effect of shaping the entire board around the fluid flow path 290. A cover 264 is provided to maintain the PCB 260 in position with respect to the inner wall 23. Locating clips 266 connect the cover 264 to the inner wall 23.

A user interface (UI) 32 is provided on the wall 20 advantageously on the first part 14a of the heater housing enabling ease of access during use of the appliance. In this embodiment, the user interface 32 is provided in two locations. A first UI 32a has three user operable buttons. A push switch 330 to activate and deactivate the appliance and two rocker switches 340, 342 controlling flow and temperature.

The first UI 32a is layered and has a first layer having the user operable buttons as an externally accessible feature with a membrane 350 which sticks onto an internal surface of the wall 20 both positioning the user operable buttons and sealing the wall 20 around the first UI 32a.

The middle layer is a plastic frame 352 providing flexible actuators which engage with tact switches located on an inner layer 366 when pressed. There is one flexible actuator 354 associated with the on/off button 330 which engages with a first tact switch 356 when pressed. There are two flexible actuators 344 associated with each one of the heat and flow rocker switches 340,342 and these engage with one of four tact switches. A push on a first end 340a, 342a of each rocker switch engages with one of a first pair of tact switches 346 and causes an increase in either heat or flow. A push on a second end 340b, 342b of each rocker switch engages with one of a second pair of tact switches 362 and causes a decrease in either heat or flow i.e. a change in state of the switch. In this example there are three flow settings and an array of three LEDs is provided to indicate visually which flow setting is in current use. In this example there are four heat settings and another array of three LEDs is provided to indicate visually which heat setting is in current use. When no LEDs are on in the array of LEDS for the heat setting the heat setting is cold. The LEDs 348 are conveniently provided either side on the on/off button and the heat rocker switch has a marker 358 to enable a user to distinguish between each rocker switch function, the marker can be a coloured, for example a red dot.

The inner layer 366 is a UI PCB onto which the five tact switches 356, 346, 362 are mounted. This inner layer 366 is retained in position via a clip 254 provided on the inner wall 23 which interacts with a corresponding lug 368 on the plastic frame 352. The inner layer 366 additionally provides a connection point 370 for wires from an RFid reader and a thermistor bead 386 which are located at the fluid outlet 28 and will be discussed in more detail later.

The second UI 32b is provided diametrically opposite the first UI 32a and comprises a single cold shot button 332. The cold shot button 332 is also provided with a membrane (not shown) which sticks onto an internal surface of the wall 20 both positioning the cold shot button and sealing the wall 20 around the second UI 32b. This cold shot button 332 engages via a flexible plastic actuator 334 with a different type of tact switch 336, one which is only activated when pressure is applied. The plastic actuator 334 includes a locating pin 322 which connects to an appropriately sized recess 324 in the inner wall and a pair of end clips 326 which clip into projections 328 provided on the inner wall 23. The function is to temporarily cut power to the heater to enable the hair to be quickly cooled once the desired style for a tress of hair or a region of hair has been styled to cool the hair and set it in the style. The different type of tact switch 336 is mounted onto a flexible electrical connector 338 which connects via a first connector 270 to the further PCB 366 and via a second connector 272 the PCB 260. The inner wall 23 includes a moulded recess 274 to accommodate the flexible electrical connector 338 locating it within the appliance and protecting the wiring within the connector from damage.

The inner wall 23, may incorporate recesses to accommodate the wiring as it routes through the appliance from the PCB 260 to the airflow generator 36, heater assembly 34, or air exit assembly 380.

The flexible electrical connector 338 communicates the status of the cold shot button 332 to the inner layer 336 and the status of all user activated buttons from the inner layer 336 to the PCB 366 i.e. the status of the push switch 330 to activate and deactivate the appliance, two rocker switches 340, 342 controlling flow and temperature and of the cold shot button 332. This status information is passed to the heater controller 50 and airflow generator control circuitry 60 for appropriate response.

A portion of the inner wall 23 comprises an array of apertures 192 and sandwiched between the inner wall 23 and the wall 20 is a layer of felt material 194. The felt material 194 absorbs noise generated within the fluid flow path 290.

Between the air inlet 28 and the flow generator 36 is a flow conditioner 196. The flow conditioner 196 is an array of hexagonal apertures which extends across the fluid flow path 290 and serves to remove small eddies and swirls in the air flowing with the fluid flow path 290 prior to air entering the flow generator 36.

Downstream of the flow generator 36 is the heater assembly 34. The type of heater is not pertinent, but examples include a resistive wire heater assembly such as is disclosed in UK Patent Number GB2516249 or a ceramic heater assembly such as is disclosed in European Patent Application Number EP3568038. The heater assembly 34 is surrounded by a heater surround 302 and an air gap 304 is provided between the heater surround and the heater housing 14. The air gap 304 provides thermal insulation for the heating housing 14. At the air outlet 28, the location of the heater surround 302 and thus the air gap 204 is maintained by an air exit assembly 380.

The air exit assembly 380, is a moulded plastic part and has a number of functions. The first is to retain a downstream end of the heater assembly 34 within the heater housing 14. Full details of the retention features are described in UK patent application number GB2104986.1 but the aim is to lock the heater assembly 34 in position with respect to the air exit assembly 380. A second is to retain an air exit grille 382 which is a metal grid covering the air outlet 28 to prevent accidental ingress of features into the appliance.

A third is to provide a mount for a temperature sensor 384 which measures the temperature of air near to the fluid outlet 28. In this example, the temperature sensor 384 comprises a thermistor bead 386 mounted in housing 388 that surrounds the thermistor bead 386 and suspends the thermistor bead 386 in the fluid flow path. The housing conveniently has a base portion 388 that forms a part of the air exit assembly 380 and a pair of arms 392 that suspend the thermistor bead 286 within a surrounding housing 394. This temperature sensor 384 is in addition to the RTD temperature sensor 38 and measures air temperature rather than heater temperature and can provide an early indication of a blockage at the filter or air outlet for example. Power to the heater 36 can be restricted or stopped if the air temperature is higher than expected. A pair of thermistor wires 390 relays the temperature reading of the thermistor bead 386 to a connector 370 for connection to the inner layer 366 of the first UI 32a.

A fourth is to provide a mount for an RFid antenna 392 which relays a signal from an attachment 400 for the appliance to a connector 370 for connection to the inner layer 366 of the first UI 32a. The RFid antenna 392 enables an RFid chip installed within the attachment 400 to communicate data/information so heat and/or flow settings can be tailored for the different uses of each attachment, for example rough dry, styling, or diffuser. In addition, the absence of an attachment may be used to prevent operation of the appliance as there will be no signal. This is particularly useful if a power dense ceramic heater is used within the appliance as temperature and flow or air can be managed through the attachment before it reaches a user.

A fifth is to provide a mount for an attachment ring 394. This attachment ring 394 is made from a magnetisable material such as steel and is used to provide a magnetic attachment to the appliance for an attachment 400. Such an attachment 400 includes a magnetic ring or as shown discrete magnets 402 which cooperate with the attachment ring 394 to locate and attach the attachment 400 to the appliance. In addition, the heater housing 14b includes a recessed region 414 adjacent to and extending about the air outlet 28 and second end 24 which cooperates with a corresponding collar 404 which extends around the periphery of an inlet 406 of the attachment 400.

The attachment 400 includes an inlet end 420 and an outlet end 430 and fluid can flow from a fluid inlet 406 at the inlet end 420 to a fluid outlet at the outlet end 430. The inlet end 420 includes a collar 404 adapted to fit over a corresponding recess 414 in an appliance. Orthogonal to the collar 404 is a mating face 408 which houses two magnet segments 402. The mating face 408 is adapted to fit over the attachment ring 394 to provide a magnetic coupling for the attachment 400 as well as a mechanical coupling via the collar 404 and recess 414. Alternatively, the collar 404 and recess 414 could be dispensed with and the attachment can be solely magnetically couple to the appliance.

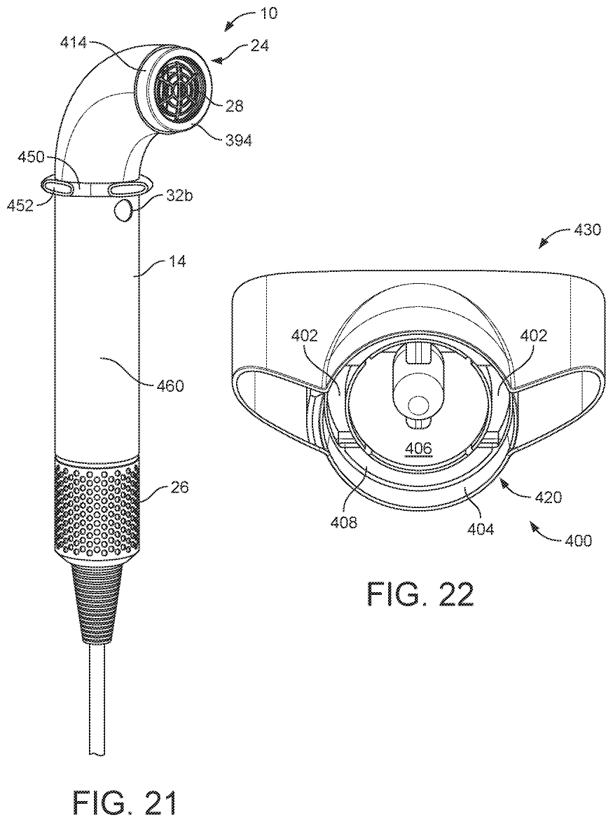

In FIG. 21, the appliance 10 comprises a grip feature 450. This is a flexible ring of, for example, a rubbery or silicon-based material which is located approximately at the junction between the first part 14a and the second part 14b of the heater housing 14. The grip feature 450 has a diameter greater than that of the heater housing 14 and it allows a user to rest the appliance 10 against the web of skin between the user's forefinger and thumb. Alternatively, or additionally, recesses 452 formed as semi-circular bites out of the grip feature 450 can accommodate a finger or thumb providing a resting place, four of such recesses could be used, it will be apparent to the skilled person that more or less recesses can also be utilised. These recesses 452 are spaced around the circumference of the grip feature 450.

The grip feature 450 may additionally comprises a sleeve 460 which may or may not be integral with the grip feature 450 such as sleeve extending from the grip feature 450 towards the fluid inlet 26.

A number of seals have been provided within the heater housing 14 to prevent fluid from flowing either from the fluid flow path 290 into the space between the inner wall 23 and the wall 20 which could cause recirculation around the airflow generator 36 or an ingress of foreign matter into the fluid flow path 290.

A first seal 470 is provided between the wall 20 and the clam shell 23 at a downstream end of the air inlet 26 to prevent unfiltered air entering the fluid flow path 290. A second seal 472 is provided at the downstream end of the inner wall 23 between the inner wall 23 and the wall 20. A third seal 474 is provided between the second part 14b of the heater housing and the inner wall 23. These seals can be O-rings or tape which is positioned and stuck to one of the surfaces to be sealed. In addition, a clam sell seal (not shown) is advantageously provided along the mating edges of the main part 180 and the clam shell 190

Whilst particular examples and embodiments have been described, it should be understood that various modifications may be made without departing from the scope of the invention as defined by the claims.

1: A haircare appliance comprising a heater housing, a heater assembly disposed in the heater housing, an airflow generator for generating an airflow through the heater housing, the airflow generator disposed in the heater housing, a circuitry housing remote from the heater housing, airflow generator control circuitry disposed in the circuitry housing, and a wire extending from the circuitry housing to the heater housing, the wire coupling the airflow generator control circuitry to the airflow generator.

2: The haircare appliance as claimed in claim 1, wherein the airflow generator control circuitry comprises a switch for controlling current flow to the airflow generator.

3: The haircare appliance as claimed in claim 1, wherein the airflow generator comprises a motor and an impeller driven by the motor, and a rotational position of the impeller is calculated using current and/or voltage values communicated to the airflow generator control circuitry over the wire.

4: The haircare appliance as claimed in claim 3, wherein the motor comprises a single-phase motor.

5: The haircare appliance as claimed in claim 1, wherein the haircare appliance comprises a pair of power supply wires for providing electrical power to the heater assembly, the pair of power supply wires extending from the circuitry housing to the heater housing, and a relay disposed within the circuitry housing, the relay interrupting a current supply path from a mains power supply to one of the power supply wires.

6: The haircare appliance as claimed in claim 5, wherein the haircare appliance comprises a thermal protection circuit disposed within the circuitry housing, and the relay is controlled by the thermal protection circuit.

7: The haircare appliance as claimed in claim 1, wherein the haircare appliance is configured to be powered by a mains power supply, and the haircare appliance comprises a power converter for providing electrical power to the airflow generator control circuitry, the power converter disposed in the circuitry housing.

8: The haircare appliance as claimed in claim 7, wherein the heater assembly comprises a heater controller, the heater controller is in communication with the airflow generator control circuitry via a pair of communication wires extending from the circuitry housing to the heater housing, and the power converter is configured to supply electrical power to the heater controller via the pair of communication wires.

9: The haircare appliance as claimed in claim 8, wherein the heater controller is configured to communicate with the airflow generator control circuitry using low voltage differential signalling.

10: A haircare appliance comprising a heater housing, a circuitry housing remote from the heater housing, an airflow generator for generating an airflow through the heater housing, airflow generator control circuitry for controlling the airflow generator, a heater assembly for heating airflow through the heater housing, the heater assembly comprising a heater, a heater controller, and heater drive circuitry controlled by the heater controller, a temperature sensor for sensing a temperature of airflow through the heater housing, a thermal protection circuit for receiving a signal from the temperature sensor, a power supply connector for connecting to a mains power supply, and a power converter for supplying DC electrical power to the airflow generator control circuitry and the heater controller, wherein the power supply connector is connected to the circuitry housing, the airflow generator, the heater assembly and the temperature sensor are disposed in the heater housing, the airflow generator control circuitry, the thermal protection circuit and the power converter are disposed in the circuitry housing, the airflow generator control circuitry comprises an airflow generator controller and airflow generator drive circuitry, the airflow generator drive circuitry is electrically coupled to the airflow generator by a first coupling, the heater controller is communicatively coupled to the airflow generator controller by a second coupling, the temperature sensor is electrically coupled to the thermal protection circuit by a third coupling, the power converter is electrically coupled to the heater controller and the airflow generator controller by a fourth coupling, the heater drive circuitry is electrically coupled to the power supply connector by a fifth coupling, and the first, second third, fourth and fifth couplings collectively comprise no more than eight wires extending between the circuitry housing and the heater housing in an electrical cable.

11: The haircare appliance as claimed in claim 10, wherein the second and fourth couplings collectively comprise a pair of communication wires that both communicatively couple the heater controller to the airflow generator controller and electrically couple the heater controller to the power converter.

12: The haircare appliance as claimed in claim 10, wherein the heater controller is configured to communicate with the airflow generator control circuitry using low voltage differential signalling.

13: The haircare appliance as claimed in claim 10, wherein the first coupling comprises a pair of airflow generator current wires electrically coupling the airflow generator drive circuitry to the airflow generator.

14: The haircare appliance as claimed in claim 10, wherein the airflow generator comprises a motor, and an impeller driven by the motor, and a rotational position of the impeller is calculated using current and/or voltage values communicated to the airflow generator control circuitry over the wire.

15: The haircare appliance as claimed in claim 14, wherein the motor comprises a single-phase motor.

16: The haircare appliance as claimed in claim 10, wherein the third coupling comprises a pair of thermal protection circuit wires electrically coupling the thermal protection circuit to the temperature sensor.

17: The haircare appliance as claimed in claim 10, wherein the fifth coupling comprises a pair of power supply wires electrically coupling the heater drive circuitry to the power supply connector.

18: A haircare appliance comprising a heater housing, a circuitry housing remote from the heater housing, an airflow generator for generating an airflow through the heater housing, an airflow generator controller for controlling the airflow generator, a heater for heating an airflow through the heater housing, a heater controller for controlling the heater, and a power converter for supplying DC electrical power to the airflow generator controller and the heater controller, wherein the airflow generator, the heater and the heater controller are disposed in the heater housing, the airflow generator controller and the power converter are disposed in the circuitry housing, and the heater controller is electrically coupled to the power converter and communicatively coupled to the airflow generator controller by a pair of wires extending from the circuitry housing to the heater housing.

19: The haircare appliance as claimed in claim 18, wherein the haircare application comprises communication circuitry for injecting communication signals onto and decoding communication signals from, the pair of wires, the communication circuitry disposed in both the circuitry housing and the heater housing.

20: The haircare appliance as claimed in claim 18, wherein the heater controller is configured to communicate with the airflow generator controller using low voltage differential signalling.
